(19) United States
(12) Patent Application Publication
(10) Pub. No.: US 2010/0179378 A1
(43) Pub. Date: Jul. 15, 2010

(54) Insemination catheter for artificial insemination in animals

(76) Inventor: Sheng-Jui Chen, Pyng-Jenn City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/320,022

(22) Filed: Jan. 15, 2009

(51) Int. Cl. A61D 19/02

(52) U.S. Cl. 600/35

(57) ABSTRACT

The invention discloses an improved insemination catheter for artificial insemination in animals, characterized in which a center orifice disposed at the rear end of the nozzle for connecting the catheter tube is a blind orifice, and a diversion slit is configured between and connecting the front end of center orifice and the front end of nozzle, the diversion slit being opened when semen in the catheter tube is being squeezed and closed when semen in the catheter tube is not being squeezed. As such, the front end of the nozzle would be closed when it is inserted along with the catheter tube into the vaginal orifice of female animal body during artificial insemination such that contaminants from outside the female animal body or lubricant used will not flow into the center orifice of the nozzle, thereby enhancing the safety of artificial insemination. When the animal semen is squeezed in from the rear end of catheter tube, the diversion slit will open under pressure to allow the semen to be released smoothly, rapidly and accurately into the animal uterus, thereby enhancing the efficiency of artificial insemination. Under the circumstance where the diversion slit is closed when not under pressure, semen flown into the animal uterus or amassed around the cervix will not back flow into the center orifice of nozzle or the catheter tube, thereby reducing wasteful outflow of semen and increasing the chance of conception.

### BACKGROUND OF THE INVENTION

1) Field of the Invention

The present invention relates to an improved insemination catheter for artificial insemination in animals, more particularly a simple and novel design of improved insemination catheter for artificial insemination in animals that is easy and convenient to use, effectively prevents the backflow of semen already in animal uterus, thereby greatly enhancing the efficiency of artificial insemination and reducing the waste of semen, and prevents the entry of lubricant and contaminants into the uterus through vaginal orifice and vagina, thereby ensuring the health of the female animal. The present invention is applicable, ideal and inventive.

2) Description of the Prior Art

The assembly and operation of a conventional artificial insemination catheter are as shown in FIG. 1, FIG. 2, FIG. 3 and FIG. 4. An artificial insemination catheter typically comprises a catheter tube 10 and a nozzle 20 installed at the front end of catheter tube 10. As shown in FIG. 5, the catheter tube 10 is made of flexible material that can deliver the nozzle 20 to the cervix 12 of uterus through the vaginal orifice 111 and vagina 11 of the female animal body 1. The nozzle 20 is made of soft material. Regardless of the shape and material of the nozzle 20, it is disposed with a center orifice 201 at the rear end for the insertion and coupling of the catheter tube 10, and a spray orifice 202 is disposed between the center orifice 201 and the front end of nozzle 20. As such, when the nozzle 20 is inserted into the cervix 12 of female animal body 1 and the semen dispenser 30 (semen bottle or bag) is pumped, the semen contained in the semen dispenser 30 is squeezed into the rear end of catheter tube 10 and then released into the animal uterus 13 from the spray orifice 202 of the nozzle 20 to complete the artificial insemination. Although the configuration and operation of such artificial insemination device achieve the purpose of artificial insemination in animals effectively, there are some drawbacks:

1. When performing artificial insemination, the operator needs to pump the semen contained in the semen dispenser 30 entirely into the female animal body 1 in a short period of time (in about one minute) after the nozzle 20 of the insemination catheter has been extended to the cervix 12. Subsequently, the operator will separate the empty semen dispenser 30 from the catheter tube 10 and leave the insemination catheter inside the female animal body 1 for a period of time to give the female animal in heat a sense of copulation so as to enhance the efficiency of artificial insemination. The operator then goes on to inseminate other female animals. However the semen that was released instantaneously from the nozzle 20 is usually amassed at the cervix 12 and then enters the uterus 13 gradually under uterine contraction. What happens most frequently at this time is that semen that has not entered the uterus would backflow into the catheter tube 10 via the open spray orifice 202 of the nozzle 20 and flow out from the catheter tube 10 from its rear end, resulting in waste of semen, and at the same time, decreasing the efficiency of artificial insemination and conception rate.

2. In the artificial insemination operation described above, the operator would soak the nozzle 10 into a container filled to lubricant to coat the entire nozzle surface with a layer lubricant, which will make the insertion of nozzle 10 into the cervix 12 of female animal body 1 through vaginal orifice 111 and vagina 11 smoother without injuring the female animal body 1. However the constantly open spray orifice 202 would let large amount of lubricant to flow in and adhere to the catheter tube 10 when the nozzle 20 is soaked in the lubricant container. When the nozzle 20 is extended inwardly through the vaginal orifice 111 and vagina 11, contaminants from outside the female animal body 1 tend to enter the nozzle 20 through the spray orifice 202 and then into the animal uterus 13 together with the lubricant and semen. As such, the risk of bacteria infection and inflammation of the vagina, cervix, and even the uterus of the animal during artificial insemination is high and, at the same time, the safety of fetus carried in the uterus is jeopardized.

In light of the drawbacks described above, the author proposes an invention that is an improvement of the conventional artificial insemination catheter.

### SUMMARY OF THE INVENTION

The primary object of the present invention is to provide an improved insemination catheter for artificial insemination in animals, characterized in which a center orifice disposed at the rear end of the nozzle for connecting the catheter tube is a blind orifice, and a diversion slit is configured between and connecting the front end of the center orifice and the nozzle, the diversion slit being opened when semen in the catheter tube is being squeezed and closed when semen in the catheter tube is not being squeezed. As such, the front end of the nozzle would be closed when it is inserted along with the catheter tube into the vagina of female animal body during artificial insemination so that contaminants from outside the female animal body or lubricant used will not flow into the center orifice of the nozzle, thereby enhancing the safety of artificial insemination. When the animal semen is squeezed in from the rear end of catheter tube, the diversion slit will open under pressure to allow the semen to be released smoothly, rapidly and accurately into the animal uterus, thereby enhancing the efficiency of artificial insemination.

Another object of the invention is to provide an improved insemination catheter for artificial insemination in animals, characterized in which under the circumstance where the diversion slit of the nozzle is closed when no pressure is exerted, semen flown into the animal uterus or amassed around the cervix will not back flow into the center orifice of nozzle or the catheter tube, thereby reducing wasteful outflow of semen and increasing the conception rate.

The objects, features and effects of the invention are described in detail below with embodiments in reference to the accompanying drawings.

### BRIEF DESCRIPTION OF THE DRAWINGS

FIG. 1 is a perspective view (1) of a conventional insemination catheter for artificial insemination in animals.

FIG. 2 is a schematic diagram of FIG. 1.

FIG. 3 is a perspective view (2) of a conventional insemination catheter for artificial insemination in animals.

FIG. 4 is a schematic diagram of FIG. 3.

FIG. 5 is a schematic diagram showing the operation of a conventional insemination catheter for artificial insemination in animals.

FIG. 6 is a perspective view of an example of the invention.

FIG. 7 is a schematic diagram of FIG. 6.

FIG. 8 is a schematic diagram showing the nozzle in FIG. 7 with part of the nozzle enlarged and the diversion slit closed.

FIG. 9 is a schematic diagram showing the nozzle in FIG. 7 with part of the nozzle enlarged and the diversion slit open releasing the semen.

FIG. 10 is a schematic diagram of an artificial insemination catheter with a second catheter tube according to the invention.

FIG. 11 is a schematic diagram showing the second catheter tube in FIG. 10 extending forward.

FIG. 12 is a schematic diagram showing the second catheter tube in FIG. 10 with part of the second nozzle enlarged and the diversion slit closed.

FIG. 13 is a schematic diagram showing the nozzle in FIG. 10 with part of the second nozzle enlarged and the diversion slit open releasing the semen.

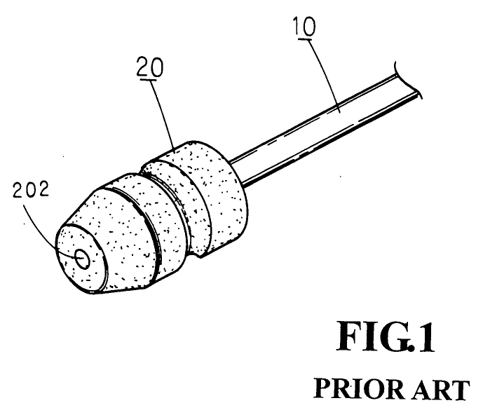

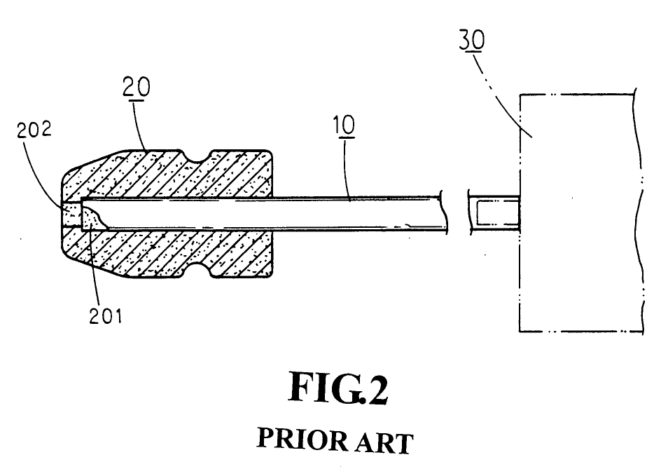

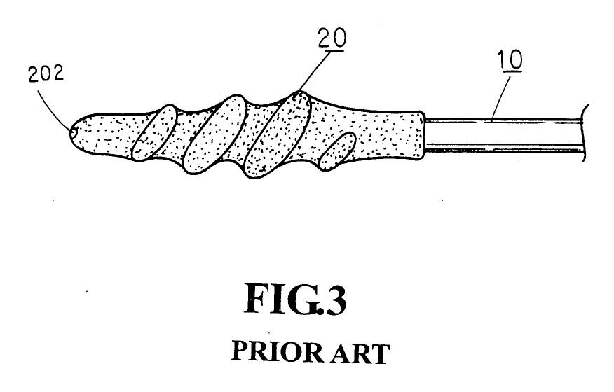

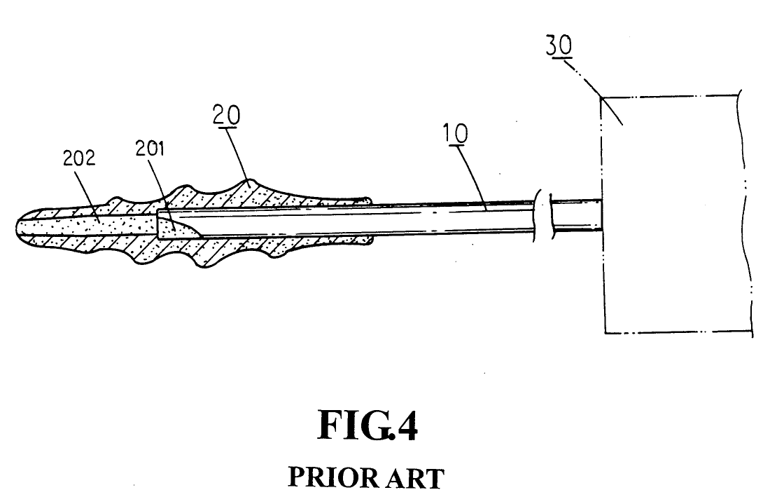

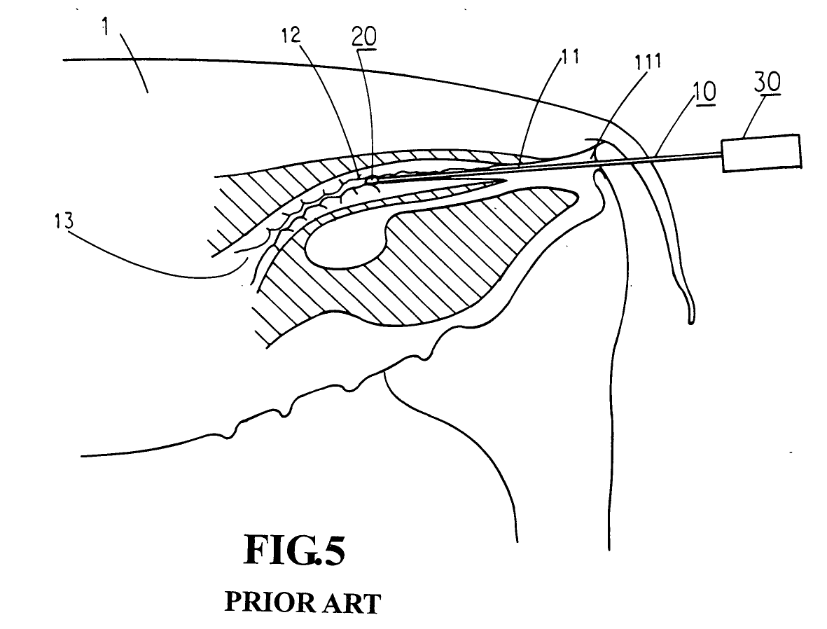

### DETAILED DESCRIPTION OF THE INVENTION

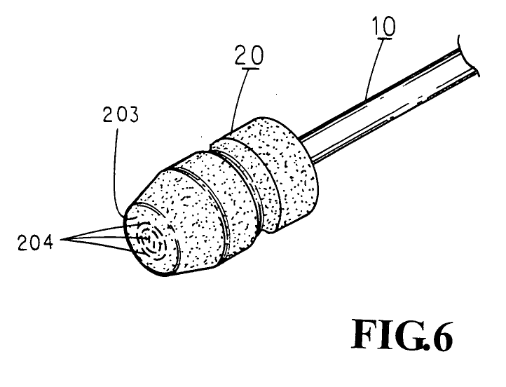

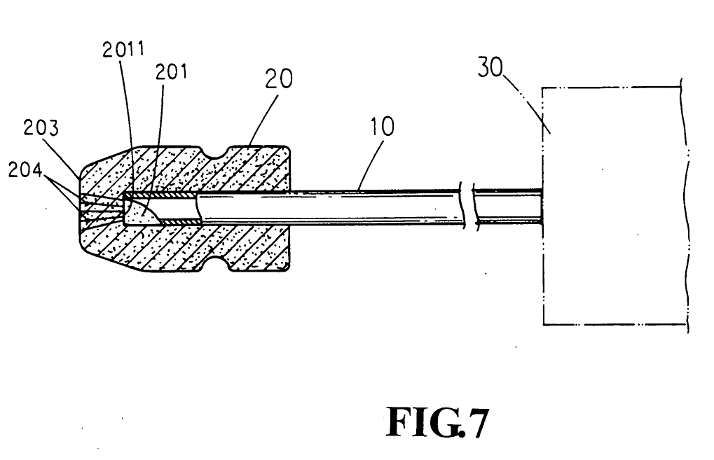

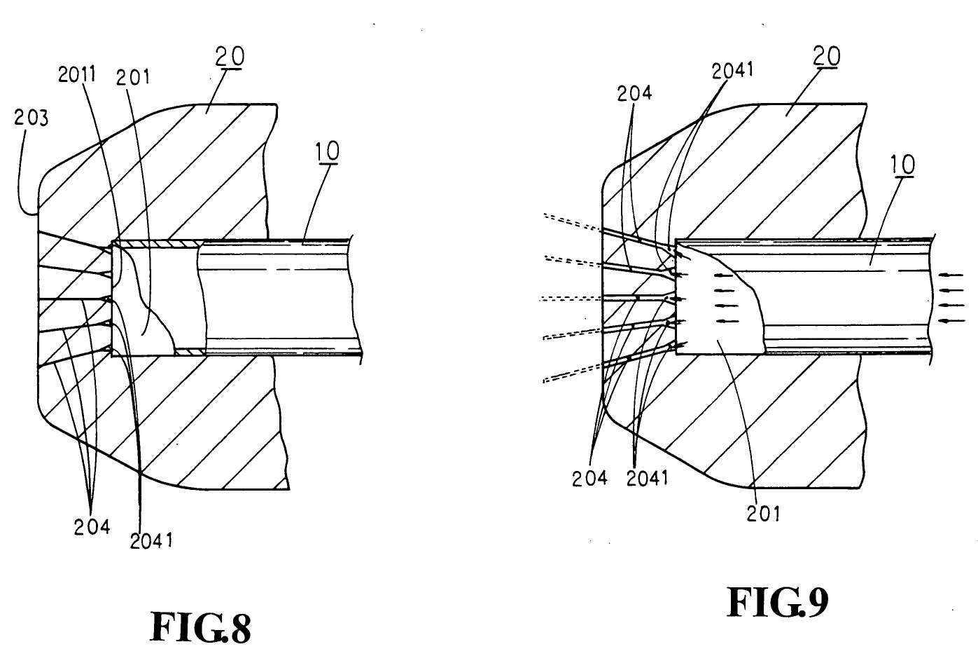

Referring to FIGS. 6 and 7, the improved insemination catheter for artificial insemination in animals according to the present invention provides a simple improvement of the soft-textured nozzle 20 installed at the front of the catheter tube 10, characterized in which the center orifice 201 of the elastic soft-textured nozzle 20 for coupling the catheter tube 10 is disposed from back to front as a blind orifice and a diversion slit 203 is disposed between and connecting the front end 2011 of the center orifice 201 and the front end 203 of the nozzle 20. Subject to the elastic action of the nozzle 20 contracting inwardly and extending outwardly, the diversion slit 204 will stay closed when there is no pressure exerted on the center orifice 201 from the catheter tube 10, and when the catheter tube 10 exerts pressure on the center orifice 201, the diversion slit 204 will be propped open to the outside. Using the invention as described above, when the operator prepares for artificial insemination by soaking the nozzle 20 in a lubricant container, the diversion slit 204 linking the front end 203 of nozzle 20 and the front end 2011 of center orifice 201 is closed (as shown in FIG. 8) so that lubricant will not flow into the center orifice 201 or the catheter tube 10 but will only coat the surface of the nozzle 20. Subsequently when the nozzle 20 is extended along with the catheter tube 10 into the vagina of the animal, the lubricant on the nozzle surface will adhere to the walls of the vaginal orifice and vagina instead of being carried into the cervix. More particularly, the closed diversion slit 204 fully prevents any contaminant from outside the female animal body from entering the center orifice 201 or the catheter tube 10. As such, the nozzle 20 that enters the cervix is clean, which renders the artificial insemination process safer. Subsequently when the operator squeezes in semen in the semen dispenser 30 (as shown in FIG. 7) from the rear end of the catheter tube 10, the diversion slit 204 of nozzle 20 disposed at the front end of catheter tube 10 will prop open automatically under pressure (as shown in FIG. 9), and the semen squeezed into the catheter tube 10 can be released smoothly, rapidly and accurately into the uterus via the diversion slit 204 to undergo artificial insemination.

While semen in the catheter tube 10 is totally released from the nozzle 20 and the catheter remains inside the female animal body, the diversion slit 204 of the nozzle 20 is closed for there is no pressure from the catheter tube 10. Under the circumstance, semen around the nozzle 20 and temporarily amassed at the cervix of uterus cannot backflow into the center orifice 201 and the catheter tube 10 via the closed diversion slit 204, but will enter the uterus gradually under the force of uterine contraction, thereby effectively reducing the waste of semen outflow. In particular, as all semen pumped into the catheter tube enters the uterus, it increases the efficiency of artificial insemination and the chance of conception.

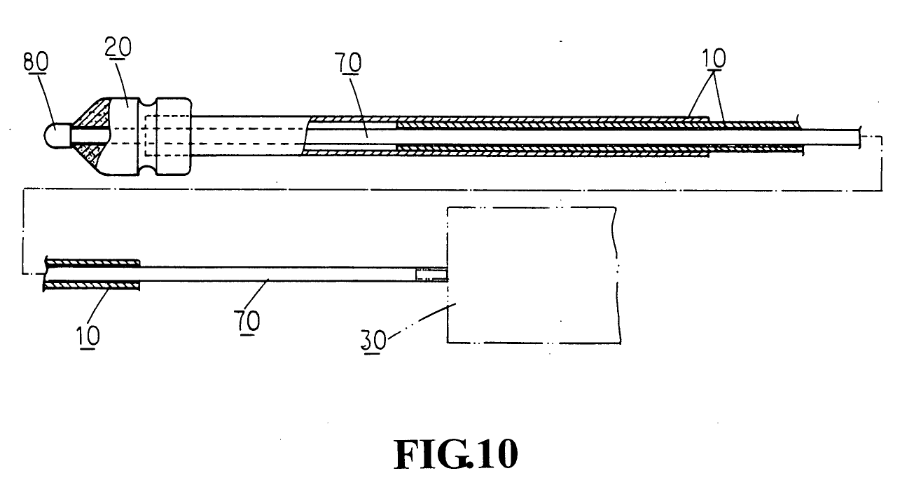

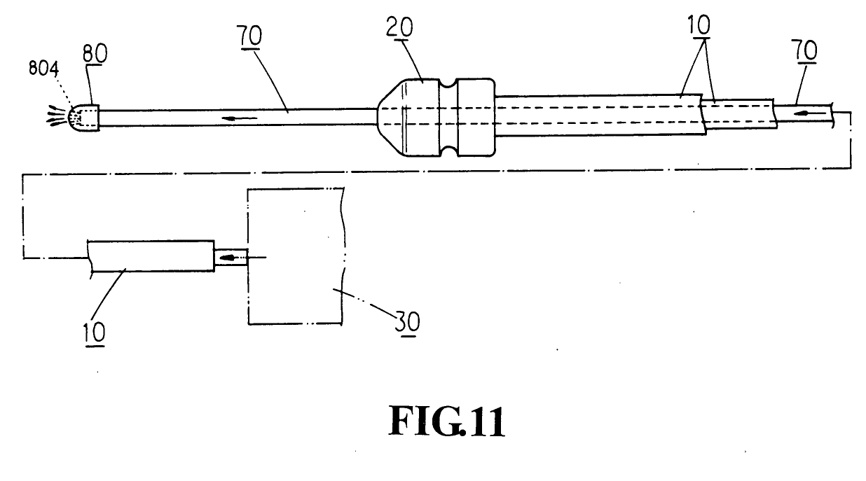

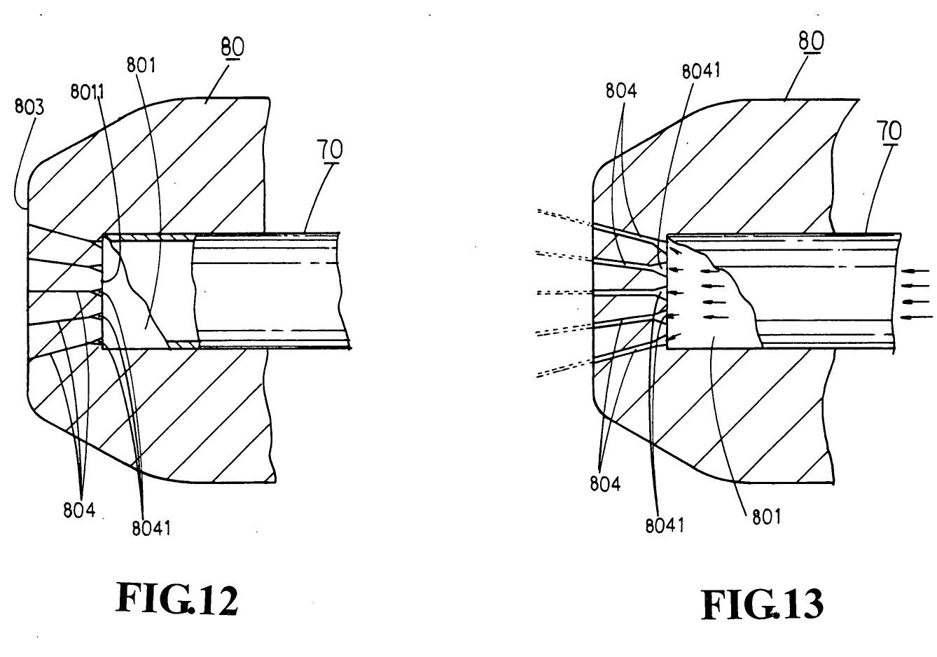

As shown in FIGS. 10, 11, 12 and 13, the improved nozzle according to the invention can be applied to artificial insemination catheter with a second catheter tube. That is, the improved nozzle 80 is installed at the front end of the second catheter tube 70. When the first nozzle 20 of the first catheter tube 10 is extended to the cervix of the animal uterus, the operator pushes in the second catheter tube 70 mobily disposed inside the first catheter tube 10 for a preset distance (see FIG. 11) such that the second nozzle 80 installed at the front end of the second catheter tube 70 is also moved forward to a preset position. After semen in the semen dispenser 30 is squeezed in from the rear end of the second catheter tube 70, the diversion slit 804 disposed between the front end 803 of the second nozzle 80 and the front end 8011 of the center orifice 801 is propped open automatically to allow semen into the animal uterus smoothly, rapidly and accurately as described above. Similarly, the diversion slit 804 becomes closed automatically when there is no pressure from the second catheter tube 70 (see FIG. 12). As described above, neither lubricant used in artificial insemination nor contaminants from outside the female animal body will be brought into the animal body in the artificial insemination process, which might endanger the health of the animal or the fetus inside the uterus. Similarly, semen released from the second nozzle 80 will not backflow into the center orifice 801 or the second catheter tube 70, but is fully delivered into the uterus. With no semen wasted, the efficiency of artificial insemination and the chance of conception are enhanced.

In line with the shape and size of the nozzle 20 and second nozzle 80, there can be a plurality of diversion slits 204, 804, and an enlarged hole tapering in shape 2041, 8041 can be configured at the junction between the diversion slit 204, 804 and the front end 2011, 8011 of the center orifice 201, 801 to render the release of semen in the catheter tube 10 and the second catheter tube 70 even smoother and more rapidly.

The present invention offers at least the following advantages:
1. It can prevent the lubricant used and contaminants from outside the animal body from entering the uterus, thereby ensuring the safety of the female animal and fetus inside the uterus.
2. It decreases waste resulting from semen outflow, making the whole artificial insemination process more economical.
3. Semen is fully delivered into the animal uterus, thereby increasing the efficiency of artificial insemination and the chance of conception.
4. The device is simple in design, convenient to make, and economical.

1. An improved insemination catheter for artificial insemination in animals, comprising a catheter tube and an elastic, soft-textured nozzle installed at the front end of the catheter tube, characterized in which:
a center orifice of the nozzle for coupling the catheter tube is a blind orifice from back to front, a diversion slit being configured between the front end of the center orifice and the front end of the nozzle and subject to the elastic action of the nozzle contracting inwardly and extending outwardly such that the diversion slit is closed when the catheter tube is not exerting pressure on the center orifice and automatically propped open to the outside when the catheter tube exerts pressure on the center orifice.

2. The improved insemination catheter according to claim 1, wherein the diversion slit of the nozzle is one or plural in number.

3. The improved insemination catheter according to claim 1, wherein an enlarged hole tapering in shape is configured at the junction between the diversion slit of the nozzle and the front end of the center orifice.

4. An improved insemination catheter for artificial insemination in animals, comprising a first catheter tube, a second catheter tube, a first nozzle installed at the front end of the first catheter tube, and an elastic soft-textured second nozzle installed at the front end of the second catheter tube, wherein the second catheter tube is mobily disposed inside the first catheter tube, characterized in which:
a center orifice of the second nozzle for coupling the second catheter tube is a blind orifice from back to front, a diversion slit being configured between the front end of the center orifice and the front end of the second nozzle and subject to the elastic action of the second nozzle contracting inwardly and extending outwardly such that the diversion slit is closed when the second catheter tube is not exerting pressure on the center orifice and automatically propped open to the outside when the second catheter tube exerts pressure on the center orifice.

5. The improved insemination catheter according to claim 4, wherein the diversion slit of the second nozzle is one or plural in number.

6. The improved insemination catheter according to claim 4, wherein an enlarged hole tapering in shape is configured at the junction between the diversion slit of the second nozzle and the front end of the center orifice.
